(19) United States
(12) Patent Application Publication
(10) Pub. No.: US 2025/0385499 A1
(43) Pub. Date: Dec. 18, 2025

(54) MODULAR CABLING AND CONNECTION SYSTEM COMPRISING KERBS, JUNCTION BOXES, CORNER BOXES AND ASSOCIATED USES

(71) Applicants: Smart Energy Lab – Association, Lisboa (PT); EDP INOVAÇÃO S.A, Lisboa (PT); EDP COMERCIAL-COMERCIALIZAÇÃO DE ENERGIA, S.A, Lisboa (PT); WITHUS – INOVAÇÂO E TECNOLOGIA, LDA, Aveiro (PT)

(72) Inventors: HELDER DANIEL DA ROCHA SANTOS, ALMADA (PT); JOÃO PEDRO PEREIRA PINTO, LISBOA (PT); ANTÓNIO COUTINHO, LISBOA (PT)

(21) Appl. No.: 19/240,133

(22) Filed: Jun. 17, 2025

(30) Foreign Application Priority Data
Jun. 18, 2024 (PT) 119533

(51) Int. Cl. H02G 3/06; H02G 3/04; H02G 3/08; H02G 3/14; H02G 3/16

(52) U.S. Cl. CPC H02G 3/0616; H02G 3/0481; H02G 3/083; H02G 3/14; H02G 3/16

(57) ABSTRACT

The invention is related to a modular wiring passage and junction system (10) for supplying power to electric vehicle chargers or other electrical devices in the public road.

The modular system (10) of the invention comprises curb elements (11) connected and aligned with each other and with junction box elements (12) and corner box elements (13).

To close the junction box (12) and the corner box (13) elements there exist junction box covers (15) and corner box covers (17) which are removable by means of a cover removal device (16).

The curb element (11), the junction box element (12) and the corner box element (13) comprise through holes in their interior for the passage of wiring and on a front face an inclined portion (113) for an access ramp.

### CROSS REFERENCE TO RELATED APPLICATIONS

This application claims the benefit of priority of Portuguese Patent Application No. 119533, filed Jun. 18, 2024, the contents of which are incorporated herein by reference in their entirety.

### TECHNICAL DOMAIN

The subject matter of this application is comprised within the inventions that include infrastructures for electrical connections in the public road, in particular, the present application is related to a curb and junction boxes and corner boxes modular system for the passage of miscellaneous wiring and accommodation of connections for supplying electricity to apparatuses installed in the public road.

### BACKGROUND

The opening of ditches in the public road for installing miscellaneous wiring and electrical connections, whether for the supply of electric power to charging devices for electric vehicles, whether for public lighting, parking meters in parking lots, urban information furniture, bus stops, charging devices for bicycles and scooters, telecommunication antennas, among others, results in countless problems. From the beginning, the associated construction demanding ditches with the corresponding earthmoving, high costs and execution time that limits the circulation of people and vehicles, increasing traffic queues, waiting times and air pollution. In addition, the lengthy procedures for obtaining the licenses for said construction work contribute to the delays and extension of traffic disturbances, as well as the damage to the environment. Additionally, ditches in public roads result in increased execution difficulties, in cases where the technical drawings made available by the construction clients are not always exempt from errors, the gas, water, electricity and telecommunication infrastructures do not always comply with the regulation distances, the mandatory compliance with the profiles for low voltage ditches defined by the normative technical drawings of the clients, for example, low voltage power distribution providers constitute an additional limitation, among others.

### PRIOR ART

Swedish patent application SE 2250811 A1, by applicant WAYBLER A B [SE], published on Dec. 19, 2023, discloses a curb with a longitudinal cable channel which passes between a first and second short side of the curb. The longitudinal cable channel is configured to carry at least one electrical cable. The cable channel comprises at least one upward opening to provide access for a charging post to at least one cable in the longitudinal cable channel. A first flat long side which extends along the entire length of the curb is configured to be arranged between a level-separated sidewalk and a road with the first flat long side facing the sidewalk. The invention further refers to a charging post for the proposed curb.

This solution does not entirely utilize the useful volume of the interior of the curb, thus promoting the opening of ditches for the passage of additional cables, resulting from the installation of new services that include, for example, signal transport by optical fiber or others. In addition, the solution of said Swedish patent application includes blocks placed above floor level, which is not recommended for safety reasons and, finally, this solution does not have a modular character, becoming inflexible for tighter spaces or which have less conventionally configured sidewalks, not allowing for surface boxes for alteration of the wiring configurations (for example, to increase the contracted power).

Thus, there remains the need for a modular system which is able to overcome the prior art problems.

### SUMMARY OF THE INVENTION

The invention is related to a curb and junction boxes and corner boxes modular system for the passage of miscellaneous wiring and connections for installation in the public road, in sidewalks or in areas of circulation of people and/or vehicles, for supplying electrical power to electric vehicle chargers, to parking meters, to publicity installations, public lighting, bus stops, bicycle and scooter charging devices, telecommunication antennas, among others.

In some embodiments of a first aspect, the present invention is related to a modular system comprising at least one curb element, at least one junction box element, at least one junction box cover and at least one cover removal device.

In some embodiments of the first aspect, the modular system of the present invention further comprises at least one corner box element and at least one corner box cover.

The elements which are part of the modular system according to the present invention are preferably made from material that includes cement, bottom ash, crushed limestone, sand, recycled concrete, recycled glass and adjuvants. Preferably, the concrete material further includes propylene fiber to grant greater resistance, or it includes any other bituminous materials which can confer greater resistance to the final product. There may further be included other natural or synthetic polymers to provide greater resistance to the final product. This can be conditioned by the number of through holes to be included in the elements according to the invention.

The elements that comprise the modular system according to the present invention are configured to be aligned to each other, that is, curb element with curb element, curb element with junction box element, curb element with corner box element, or even corner box element with junction box element, among other possible combinations.

In fact, the elements comprising the modular system of the present invention can be aligned with any other elements comprising the modular system. Additionally, after the modular system of the present invention is installed on a public road, some component elements can be replaced by others, of the same type or of another type, without the need to open ditches in the road.

In another aspect, the present invention is related to uses of the modular system for passage of electrical cables, communication cables, connecting wires, optical fiber, through one or more through hole of the curb and through one or more through hole of the junction box and/or through one or more through hole of the corner box, and in the installation of connections of these electrical cables, communication cables, connecting wires, optical fiber inside the junction box.

### Solution of the Problem

The present invention solves the problems of the prior art by means of a solution which solves the above described problems of the prior art, consisting of an infrastructure based on prefabricated concrete curbs, perforated, which can enable the distribution of power to electric vehicle chargers and other electrical infrastructures in a public road (public lighting, urban information furniture, parking meters, bus stops, bicycle or scooter charging devices, telecommunication antennas, etc.).

The geopolymer concrete material comprising cement, bottom (heavy) ash, crushed limestone, sand, recycled concrete, recycled glass and adjuvants, and optionally further comprising a propylene fiber mixture so as to increase the resistivity of the concrete, of which the constituting elements of the modular system of the present invention are made of, are subject to concrete quality control tests, dimensional and reflection tests. These tests are known to a person skilled in the art, and for this reason will not be discussed in detail, nor are they part of the invention. The concrete products which comprise the curb, junction box, and corner box elements of the present invention comply with the requirements of the European norm EN 13369—Common Rules for precast concrete products.

Further, the junction box and corner box elements can be provided with perforations at the base for water drainage.

### Advantageous Effects of the Invention

The modular system of the present invention allows the passage of electrical cables and/or others in a safe manner and easy to install, further enabling the modular replacement of one or more elements by others of the same type (for example, replacement of a curb element with another curb element of the same or different length and/or by a junction box or a corner box, in cases where the client's need has changed. These adaptations and replacements can be carried out without the need to open ditches, with all the above-mentioned inconveniences.

The modular system of the present invention further offers the following advantages:
it is modular
it is scalable
it is possible to choose the color of the concrete providing more freedom at marketing level.
it has no “live” corners or prominence on the surface of the sidewalk and, therefore, ensures the safety conditions to the pedestrians, particularly the blind pedestrians, which is a fundamental condition for approval in the municipal chambers.
allows easy access by means of the covers with removable tightening systems, for simple and quick checking of the wiring
perforations at the base of the junction box and corner box elements, provided in the surface box cover, for water drainage
the curb elements and the junction box and corner elements allow receiving suitable signs, such as warnings of electric hazard danger, showing that inside there exist electrical components under tension
reduction of visual impact during execution of the installation
reduction of costs related to public space occupancy rates
reduction of execution times since it is a simpler installation and for this reason the costs related to traffic restrictions are reduced
reduction of execution costs.

### BRIEF DESCRIPTION OF THE FIGURES

With the purpose of providing an understanding of the principles according to the embodiments of the present invention, reference will be made to the embodiments illustrated in the figures and to the terminology used to describe them. In any case, It must further be understood that there is no intention of limiting the scope of the present invention to the content of the figures and that any subsequent alterations or modifications of the inventive characteristic shown herein, as well as any additional applications of the principles and embodiments of the invention shown, which would occur normally to a person skilled in the art having this description in hands, are considered as being within the scope of the claimed invention.

FIG. 1A—shows a perspective view of a preferred embodiment of the modular system for wiring passage and connections according to the invention;

FIG. 1B—shows another perspective view of the preferred embodiment of the modular system for wiring passage and connections according to the invention of FIG. 1A;

FIG. 2A—shows a perspective view of another preferred embodiment of the modular system for wiring passage and connections according to the invention;

FIG. 2B—shows another perspective view of the preferred embodiment of the modular system for wiring passage and connections according to the invention of FIG. 2A;

FIG. 3A—shows a perspective view of an embodiment of the curb element of the modular system according to the present invention;

FIG. 3B—shows a side elevation view of the embodiment of the curb element of the modular system according to the present invention, represented in FIG. 3A;

FIG. 4A—shows a perspective view of another embodiment of the curb element of the modular system according to the present invention;

FIG. 4B—shows a side elevation view of the embodiment of the curb element of the modular system according to the present invention, represented in FIG. 4A;

FIG. 5A—shows a perspective view of a preferred embodiment of the junction box element of the modular system according to the invention;

FIG. 5B—shows a sectional view of a preferred embodiment of the junction box of the modular system according to the invention, of FIG. 5A;

FIG. 6A—shows a perspective view of another preferred embodiment of the junction box element of the modular system according to the invention;

FIG. 6B—shows a sectional view of a preferred embodiment of the junction box of the modular system according to the invention, of FIG. 6A;

FIG. 7A—shows a perspective view of a preferred embodiment of the corner box element of the modular system according to the invention;

FIG. 7B—shows another perspective view of a preferred embodiment of the corner box element of the modular system according to the invention, with an embodiment of the corner box cover and the cover removal device;

FIG. 8—shows a perspective view of another preferred embodiment of the corner box element of the modular system according to the invention;

FIG. 9—shows a perspective view of another embodiment of the curb element according to the invention; and

FIG. 10—shows a perspective view of a part of an embodiment of the modular system according to the invention.

### DESCRIPTION OF THE EMBODIMENTS

The technological solution of the present invention is related to a wiring passage and connections modular system, comprising, in some embodiments, one or more curb elements, one or more junction box elements and one or more junction box covers and respective cover removal device. In preferred embodiments, the modular system according to the invention further comprises one or more corner box elements with the respective one or more corner box covers, wherein said elements of the system are assembled in an arrangement suited to the clients' needs to constitute an infrastructure for electrical power connections for miscellaneous apparatuses installed on the road for public use, such as the electric vehicle chargers, the parking meters, the urban information furniture, the public lighting, bus stops, charging devices for bicycles or scooters, telecommunication antennas. Thanks to the modular advantage of the system of the invention, an infinity of configurations and arrangements can be carried out with the elements found in the present application. In the attached figures there are presented some preferred embodiments of the elements comprised in the modular system of the invention and some modular assembly embodiments are also illustrated, that is, of the modular system of the invention, which will be described in more detail with reference to the illustrative figures and are non-limiting of the scope of the present invention.

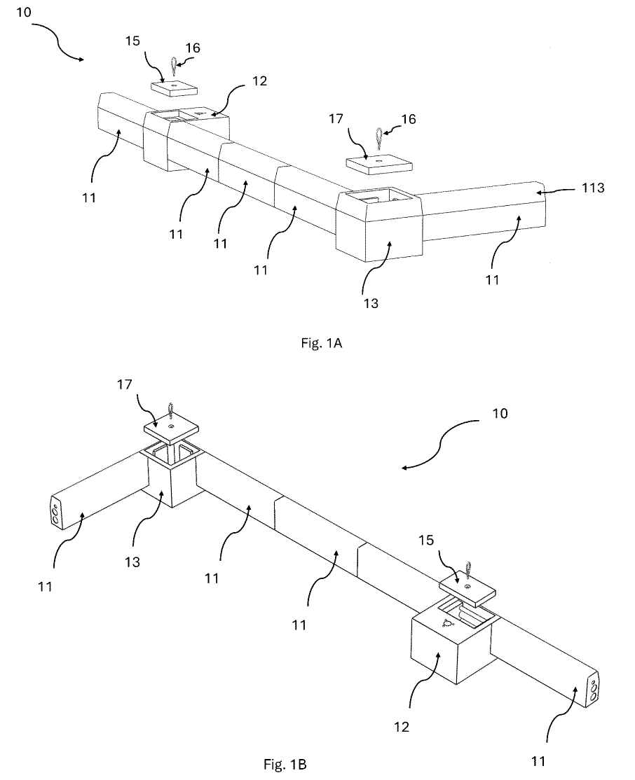

FIG. 1A represents a perspective view of a preferred arrangement of an embodiment of the modular system according to the invention. In FIG. 1A the modular system (10), from left to right, comprises a curb element (11) connected and aligned with a junction box element (12) which in turn is, on the opposite face, connected to another curb element (11), which is connected, in sequence, to two more curb elements (11), following which there is connected and aligned a corner box element (13) after which there follows one more curb element (11) identical to the former ones. A person skilled in the art will understand that more elements can be arranged so as to continue carrying out an embodiment with more elements, even though they are not represented in the figures. The modular character of the system of the invention naturally allows an infinity of arrangements and assemblies.

Still in FIG. 1A there are represented junction box covers (15) and corner box covers (17), which respectively close the junction box element (12) and the corner box element (13). These covers are both removable for visits to the respective boxes, for maintenance or other service. There is also represented in FIG. 1A an embodiment of the cover removal device (16) which will serve to remove and replace any of the junction box covers (15) or of a corner box (17). The cover removal device (16) can comprise a threaded end that screws into a thread provided in a blind hole in the junction box cover (17), for example. Naturally, the manner of engaging the cover removal device (16) can be another, as a person skilled in the art will understand. In the embodiment represented in the figures, the junction box cover (15) and the corner box cover (17) are sealed with a screw that threads into the central hole or by another suitable manner so that no water, or dust, or object, etc., enters.

The perfect alignment between the curb (11), junction box (12) and corner box (13) elements shown in FIG. 1A will be discussed relative to the following figures, which illustrate in more detail these elements of the system of the invention. In the perspective shown in FIG. 1A, the illustrated embodiment has on the front face, an angled portion, in a determined angle which can vary between 0° and 90°, to accompany an intended inclination associated with the sidewalk next to which there is installed the modular system (10) of the invention. As illustrated by FIG. 1A, all the elements of the curb (11), the junction box (12) and the corner box (13) comprise the same front face portion (113) with identical inclination, forming an uphill/downhill slope, so that the entire length of the sidewalk can comply with the specification of the client as regards said ramp. However, as will be understood by a person skilled in the art, this inclination may not be present throughout the length of the modular system (10), only in some part of the extension thereof, that is, only in some of the elements that comprise same.

FIG. 1B shows another perspective of the same modular system (10) arrangement according to the invention represented in FIG. 1A. In FIG. 1B the elements of the curb (11), the junction box (12) and the corner box (13) are illustrated from the inside, which will be the side next to the sidewalk where the modular system (10) will be installed, or next to the desired infrastructure. On the inside, no portion with inclination is illustrated, but this variation can also be applied inside the elements of the modular system (10), according to the client's requirements.

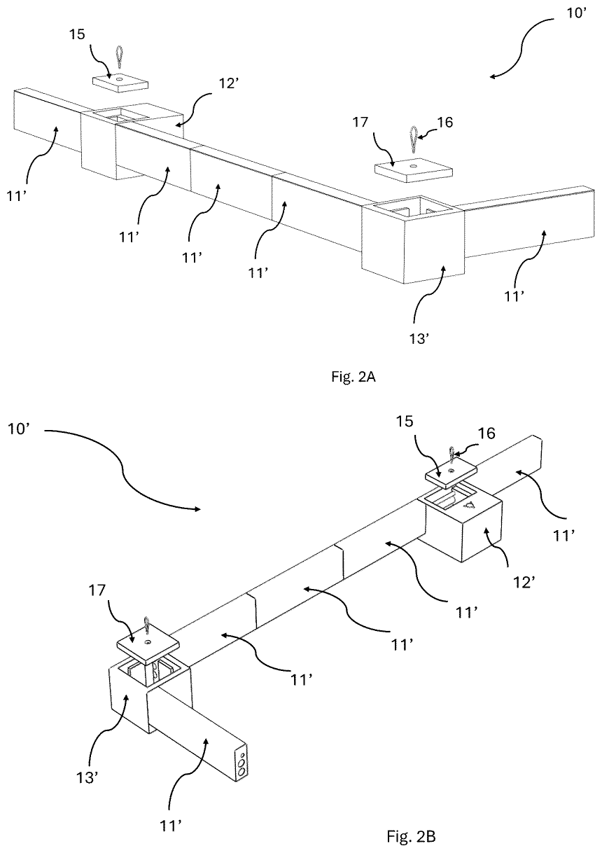

FIG. 2A represents another embodiment of the modular system (10′) according to the invention, which is extremely similar to that described for FIG. 1A, but without the front face portion (113) with inclination. The embodiment represented in FIG. 2A is not intended to comprise uphill/downhill slopes but to be an unevenness guide or separation between the sidewalk and the circulation pavement, for example. In 2A there is represented an arrangement of, from left to right, a curb element (11′) connected and aligned with a junction box element (12′) which in turn is, on the opposite face, connected to another curb element (11′), which is connected in sequence, to two more curb elements (11′), next to which there is connected and aligned a corner box element (13′) following which there is one more curb element (11′) identical to the previous ones. A person skilled in the art will understand that additional elements can be arranged so as to continue carrying out an embodiment with more elements, even though they are not represented in the figures.

Still in FIG. 2A there are further represented junction box covers (15) and corner box (17) covers, which close, respectively, the junction box element (12′) and the corner box element (13′). These covers are identical to those described for FIG. 1A and will not be described again, as well as the cover removal device (16).

FIG. 2B represents another perspective view of an embodiment of the modular system (10′) represented in FIG. 2A.

In FIG. 2B the elements of the curb (11′), the junction box (12′) and the corner box (13′) are illustrated from the inside, which will be the side next to the sidewalk where the modular system (10′) is installed, or next to the desired infrastructure. In this embodiment, the elements of the curb (11′), the junction box (12′) and the corner box (13′) are not provided with any inclination on the front face (see FIG. 2A), that is, the inclination angle will be 90° with the upper face, or the face of the junction box cover (15) or corner box cover (17), for example.

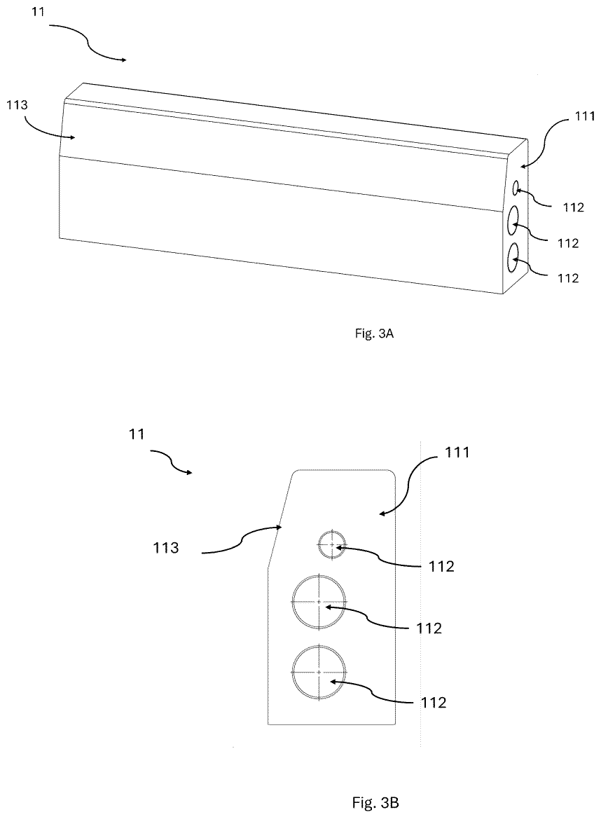

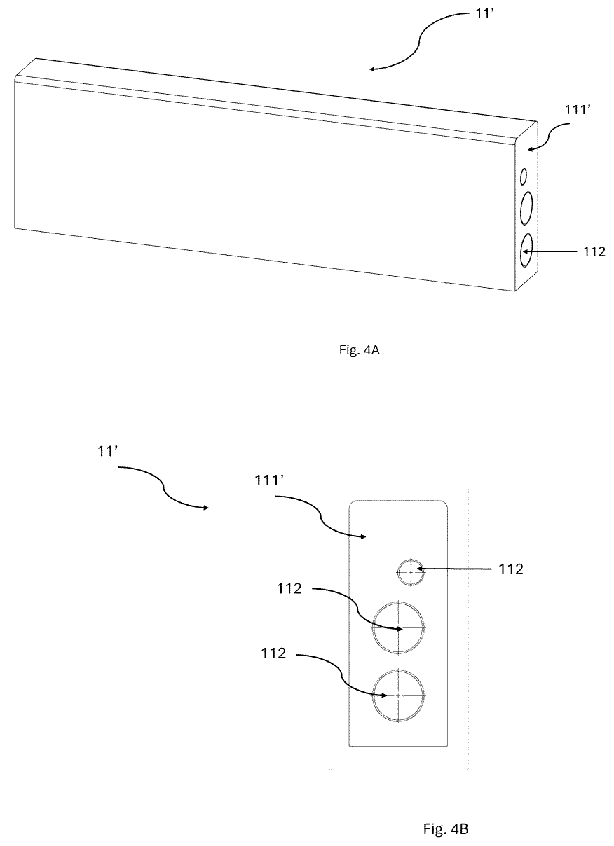

FIG. 3A represents a perspective view of an embodiment of the curb element (11) of the modular system (10) of the invention, wherein the curb element (11) has a suitable length, for example, 1000 mm length, but it can have other lengths. The shape thereof is similar to a paving stone, with two opposite curb side faces (111). The height of the curb element is also suitable for the application thereof, but being typically a sidewalk curb, it can have a height of around 300 mm but may be taller or lower than this one. The width can vary depending on the width of the sidewalk where the curb element (11) will be applied, for example, the width thereof can be 150 mm, or 200 mm, or it can alternatively be much wider, for example, the curb can extend up to a building or wall, in this way constituting all the sidewalk. The top face of the curb element (11) can be smooth, as presented in FIG. 3A, or it may acquire some adequate texture, painting of signs or colored elements. The outer face, or front, of the curb element (113) has an angled section, whereby the angle may be contained within the interval 0° to 90°, according to the client's requirements. This angled section is meant to create an easier access ramp to the sidewalk, next to which the curb element (11) is applied. Typically, in public roads, there exist curbs with ramps as illustrated in FIGS. 3A and 3B, and curbs without ramps (see FIGS. 4A and 4B).

The curb element (11) according to the present invention is made of a concrete material which must comply with applicable norms, such as, for example, European norm EN 13369—Common Rules for precast concrete products. Thus, the material which makes up the curb is a geopolymer concrete which comprises cement, bottom (heavy) ash, crushed limestone, sand, recycled concrete, recycled glass and adjuvants. Additionally, the material can further comprise propylene fiber to grant extra resistance. Optionally, the concrete material of the curb element (11) can further comprise an additive to provide the desired color.

FIG. 3B is an elevated side view of the embodiment of the curb element (11) according to the invention, represented in FIG. 3A. As represented in FIGS. 3A and 3B, the curb element (11) comprises curb through holes (112), or channels, in the interior thereof, parallel to their upper and lower faces. Said curb through holes (112) can be only one, can be two or can be three curb through holes (112). There can also be more than three, providing the resistance and other structural requirements for the curb element (11) are met. Preferably, the curb element (11) comprises 3 curb through holes (112). The curb through holes (112), or channels, can have a circular, square, rectangular, hexagonal, oblong, elliptical shape section; preferably the curb through holes' (112) section is circular. The diameter of the curb through holes (112) can be the same in all the holes of a single curb element or the diameters of, for example, 3 curb through holes (112) may be different from each other. For example, the curb element (11) represented in FIGS. 3A and 3B, can comprise 3 curb through holes (112) with diameters 32 mm, 63 mm, and 63 mm.

The curb through holes (112), or channels, are intended to accommodate the passage of wiring, such as, without limitation, electrical cables, optical fiber, electronic wires, telecommunication cables, or other cables and wires, destined to distribute electric or electromagnetic power, in the case of optical fiber, to certain points of the public roads' sidewalks. As mentioned above, the existence of said curb through holes (112) allows the installation of equipment, apparatuses or electrical devices in the public road, without the need to open ditches and other lengthy, costly works which cause many inconveniences to the circulation of people and vehicles.

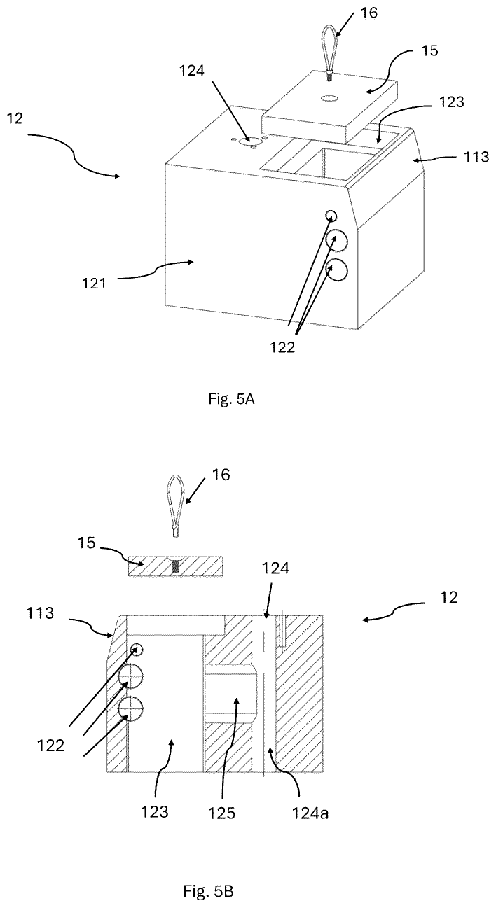

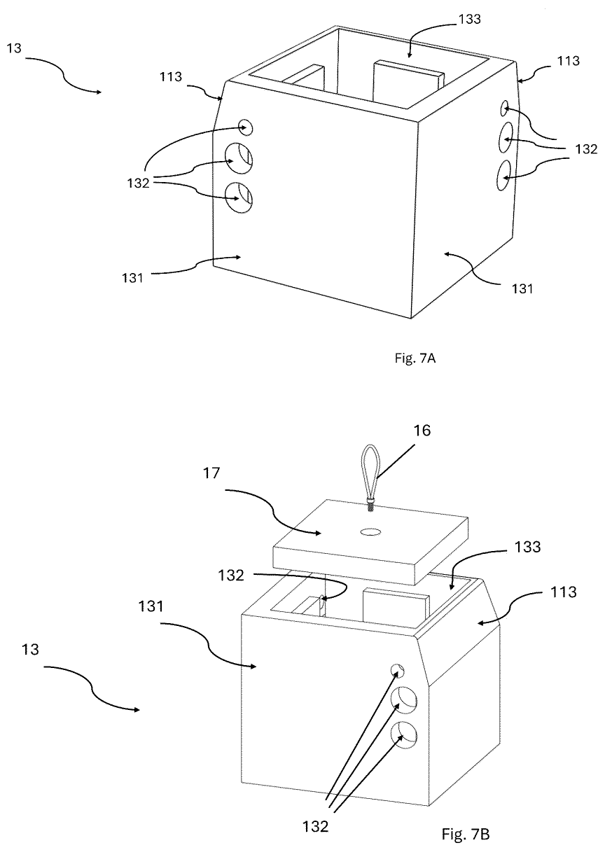

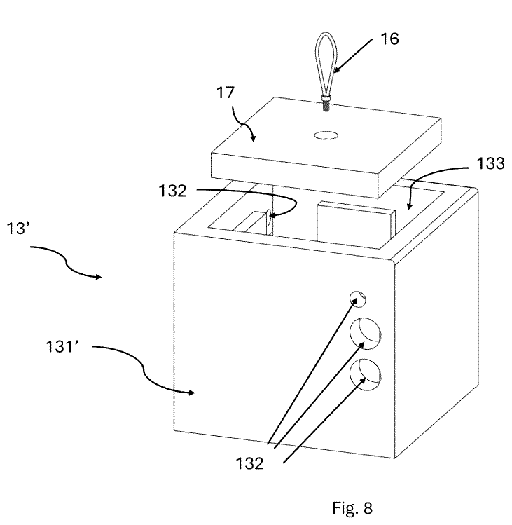

The wiring which passes through the curb through holes (112) is intended to feed apparatuses or devices, such as, for example, electric vehicle chargers, parking meters, urban information furniture, automatic vending machines, ticket purchasing terminals, among others. Said wiring will have distribution/feed or continuation points, which will be discussed ahead regarding FIGS. 5A, 5B and 7, and will have corner or curve contour points, which will be discussed in relation to FIGS. 8, 9, 10 and 11.

As represented in FIG. 3B, the curb through holes (112) are separated by a concrete material thickness which constitutes the curb element (11) in a way that the curb resistance is not compromised, and the applicable norms are complied with.

The minimum material thickness between holes will depend on the characteristics of the material, so as to grant the adequate resistance and elasticity, and also on the diameters of the holes (in the cases illustrated in the figures, one of the through holes has a diameter of 32 mm and the other two through holes have a diameter of 63 mm).

FIG. 4A represents a perspective view of another embodiment of the curb element (11′) of the modular system (10′) of the invention, wherein the curb element (11′) has an adequate length, for example, 1000 mm long, but can have other lengths. The shape thereof is similar to a paving stone, with two opposite side curb faces (111′). As described above for the embodiment illustrated in FIGS. 3A and 3B, the curb element 911′) of FIGS. 4A and 4B has a suitable height, for example, a height of 300 mm, but it can be higher or lower than this. The embodiment of the curb element (11′) illustrated in FIGS. 4A and 4B does not comprise ramping, or, in other words, the inclination angle of the outer face, or front, of the curb element (11′) is of 90° with the upper face, that is, there is no inclination intending an access ramp. This type of curb is typically intended as a guide curb. The width thereof can be 120 mm, for example, but it can be more or less than this value. For example, the width thereof can be much greater, in which case the curb can extend up to a building or wall, in this way constituting the entire sidewalk. As also described with respect to FIGS. 3A and 3B, the top, or upper face of the curb element (11′) can be smooth, as presented in FIG. 4A, or it can acquire some adequate texture, sign painting or colored elements.

The curb element (11′) illustrated in FIGS. 4A and 4B is made from the same material previously described for the curb element (11).

FIG. 4B is an elevated side view of an embodiment of the curb element according (11′) to the invention, represented in FIG. 4A. In FIG. 4B there is illustrated a side face of the curb element (111′). As already discussed above with respect to FIGS. 3A and 3B, the curb element (11′) comprises curb through holes (112) passing through the entire curb element (11′) from one side face (111′) to the other side face (111′), inside thereof, and are parallel to their upper and lower faces. Said curb through holes (112) can be only one, can be two or can be three curb through holes (112) and have the same technical characteristics and purposes as those discussed for the curb element (11) of FIGS. 3A and 3B.

FIG. 5A represents a perspective view of a preferred embodiment of the junction box element (12) of the modular system (10) of the invention, wherein the front face has an inclined portion (113) at an angle between 0° and 90° with the upper face, for example, an angle of 70° with the upper face, providing an access ramp to the sidewalk, as described for the curb element (11) represented in FIGS. 3A and 3B. Said inclined portion (113) continues the inclined portion (113) of the curb element (11) which can, for example, be aligned or limited with the junction box element (12). The junction box element (12) comprises, on the opposite side faces thereof (121) (only one of these said faces is visible in FIG. 5A), one or more, for example, three junction box through holes (122), wherein the junction box through holes (122) and the curb through holes (112) of the curb element (11) connected with the junction box element (12) (as shown in FIGS. 1A and 1B) are aligned, providing access to the wiring inserted in the curb through holes (112) to the interior of the junction box (123), as illustrated in FIG. 5A.

Similarly to what was previously described for the curb element (11), the junction box through holes (122) are separated by a thickness of the concrete material which constitutes the junction box element (12) in a way that the resistance of the curb is not compromised, and the applicable norms are complied with.

The minimum thickness of the material will depend on the characteristics of the material so as to grant the adequate resistance and elasticity, and also on the diameters of the holes (in the cases illustrated in the figures, one of the through holes has a diameter of 32 mm and the other two through holes have a diameter of 63 mm).

On the upper face thereof, the junction box element presents a junction hole (124). There is also illustrated in FIG. 5A the junction box cover (15) which is removable and serves to allow access to the interior of the junction box (123). The junction box cover (15) can be made of the same concrete material already described for the curb elements (11, 11′) according to the invention. Alternatively, the junction box cover (15) can be made of other suitable material, for example, lighter than concrete, such as plastic, other polymeric material, rubber, glass, fiber, wood or metal. FIG. 5A further illustrates a cover removal device (16), which can be a metal handle with a threaded tip, or it can be another suitable device, which screws into a blind threaded hole provided in the junction box cover (15). When the junction box cover (15) is placed over the junction box element (12), so as to close access to the interior thereof, the threaded blind hole is closed with a screw or other adequate element, to avoid ingress of water or dust in the body of the junction box cover (15).

Referring now to FIG. 5B, which shows a sectional view of the junction box element (12), the junction hole (124) continues to a junction channel (124a), wherein said junction channel (124A) communicates with the interior of the junction box (123) in a suitable manner. For example, as illustrated in FIG. 5B, the junction channel (124a) communicates with the interior of the junction box (123) by means of a derivation channel (125). The derivation channel (125) forwards the wirings that enter by the through holes of the junction box (122) and are destined to feed an apparatus or a device which will be installed next to the junction hole (124), for example, a charger for electric vehicles. Inside the junction box (123) the wiring derivation is carried out by the technician, through access that the junction box cover (15) allows, by being removed in a suitable manner, for example, as described with respect to FIG. 5A. In FIG. 5B there are illustrated the through holes (122) which cross the opposite side faces of the junction box (121) of the junction box element (12). Still in FIG. 5B there is illustrated the front face portion with inclination (113) at an angle of less than 0° with the upper face of the junction box element (12).

The wiring which is not routed to the junction box (124A) being intended to connect to an apparatus or device installed in the public road, for example, a charger for electric vehicles, or a parking meter, continues through the inside of the junction box (123) exiting on the side face of the junction box (121) opposite to that through which they entered, through the through holes of the junction box (122), continuing to the interior of the adjacent element, for example, a curb element (11), through inside the curb through holes (112).

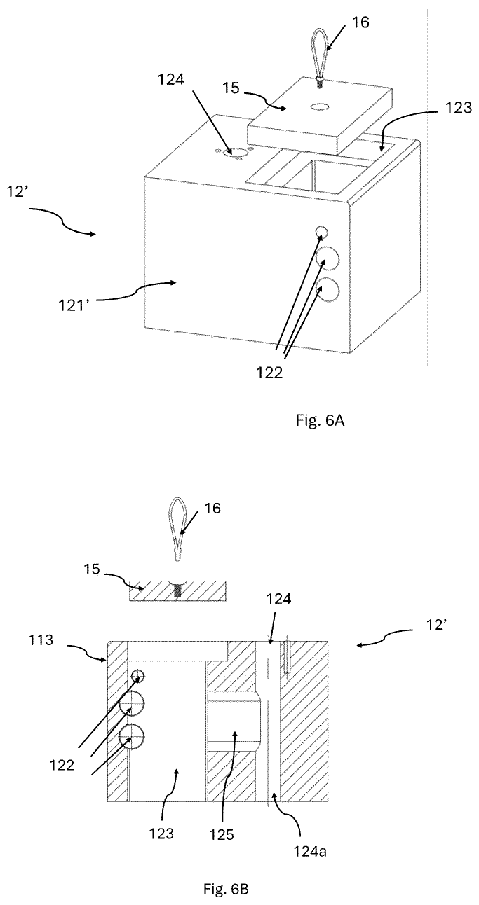

FIG. 6A represents a perspective view of another preferred embodiment of the junction box element (12′) of the modular system (10′) of the invention, wherein the front face does not have an inclined portion (113), that is, it can be considered that it is at an angle of 90° with the upper face, providing the continuation of a curb element (11′) designated as guide, represented in FIGS. 4A and 4B.

The junction box element (12′) comprises, on the side faces thereof, opposite the junction box (121′) (only one of these side faces is visible in FIG. 6A), one or more, for example, three junction box through holes (122), wherein the junction box through holes and the curb through holes (112) of the curb element (11′) connected with the junction box element (12′) (as shown in FIGS. 2A and 2B) are aligned, giving access to the wiring inserted in the curb through holes (112) to the interior of the junction box (123), as illustrated in FIG. 6A. On the upper face thereof, the junction box element presents a junction hole (124). Similarly to what was described above for FIG. 5A, there is also illustrated in FIG. 6A the junction box cover (15) which is removable and serves to allow access to the interior of the junction box (123). The materials from which the junction box is made (12′) are the same as those already described above for the curb element (11, 11′). The way to open and close the junction box element (12′) is identical in everything to that already discussed with respect to FIG. 5A.

FIG. 6B illustrates a sectional view of the junction box element (12′) wherein the frontal face portion (113) does not have the inclination for ramping, as discussed above. The remaining technical characteristics illustrated in FIG. 6B are identical to those discussed with respect to FIG. 5B.

FIG. 7A represents a perspective view, from the inside of a sidewalk, for example, of a preferred embodiment of a corner box element (13) according to the invention. The corner box element (13) presents two perpendicular front faces, which form a corner between them, for a sidewalk contour or of a public area with a corner. In these two front faces there exists a front face portion (113) which has the inclination already discussed with respect to FIGS. 3A, 3B, 5A and 5B. This inclination continues the inclination of the adjacent elements connected to the corner box element (13), for example, curb elements (11), one on each side (see FIGS. 1A and 1B), abutting with the corner box side faces (131), which are also perpendicular to each other, as illustrated in FIG. 7A.

The corner box element (13) comprises, in the perpendicular side faces thereof (131), one or more, for example, three corner box through holes (132), wherein the corner box through holes (132) and the curb through holes (112) of the curb element (11) connected with the corner box element (13) (as shown in FIGS. 1A and 1B) are aligned, giving access to the wiring inserted in the curb through holes (112) to the interior of the corner box (133).

Similarly to what was previously described for the curb element (11) and for the junction box element (12), the corner box through holes (132) are separated by a thickness of concrete material which constitutes the corner box element (13) so that the resistance of the curb is not compromised and the applicable norms are complied with.

The minimum thickness of the material between holes will depend on the characteristics of the material, so as to grant the adequate resistance and elasticity, and also on the diameters of the holes (in the cases illustrated in the figures, one of the through holes has a diameter of 32 mm and the other two through holes have a diameter of 63 mm).

In the interior of the corner box (133) the wiring and any eventual junction can be accommodated, and the wiring can make the necessary curve to turn the corner finished by the corner box element (13) of the invention. The wiring subsequently exits through the corner box through holes (132) of the other side face of the corner box (131) continuing through curb element through holes (11), for example, adjacent and connected to the corner box element (13) as already described in FIGS. 1A and 1B.

FIG. 7B illustrates another perspective of the same embodiment of the corner box (13) shown in FIG. 7A. In FIG. 7B, the front face with the inclined portion (113) is more visible. In FIG. 7B there is also illustrated an embodiment of the corner box cover (17) and the respective cover removal device (16), already discussed above. The corner box cover (17) is similar to the junction box cover (15), differing only, in some embodiments of the invention, in shape and size. In FIG. 7B, the frontal face with the inclination (113) is more visible. In FIG. 7B there is also illustrated an embodiment of the corner box cover (17) and the respective cover removal device (16), already discussed above. The corner box cover (17) is similar to the junction box cover (15), differing only, in some embodiments of the invention, in shape and size. The material which comprises the corner box cover (17) is the same material already discussed above for the junction box cover (15). FIG. 7B further illustrates the through holes (132), in the side faces that limit with the adjacent elements, for example, curb element (11), one on each side face of the corner box (131).

FIG. 8 illustrates a perspective view of the embodiment of the corner box element (11′) without the inclined portion in the front faces for ramping, similarly to what has already been discussed for the junction box element (12′).

The corner box element (13′) comprises, in the perpendicular corner box side faces thereof (131′), one or more, for example, three corner box through holes (132), wherein the corner box through holes (132) and the curb through holes (112) of the curb element (11′) connected with the corner box element (13′) (as shown in FIGS. 2A and 2B) are aligned, giving access to wiring inserted in the curb through holes (112) to the interior of the corner box (133). Similarly to what was described above for FIG. 7B, there is also illustrated in FIG. 8 the corner box cover (17) which is removable and serves to allow access to the interior of the corner box (13′). The materials which comprise the corner box element (13′) are the same already described above for the curb element 11, 11′). The way to open and close the corner box element (13′) by means of the cover removal device (16) is identical in everything to that already discussed with respect to FIG. 5A.

In certain embodiments of the modular system (10, 10′) of the present invention, the curb elements (11, 11′) the junction box elements (12, 12′) and the corner box elements (13, 13′) can present connecting elements on the side faces thereof to better make the connection between adjacent elements, for example, they can present ridges (201) and/or grooves (202), or they can present tubes, having a slightly smaller inner dimension than the inner dimension of the respective curb through holes (112), junction box through holes (122), corner box through holes (132), inserted from a determined length in the interior of the through holes of the adjacent elements and being fixed therein, or they can present full tubes, or cylinders, of the bushings types, with outer dimension slightly smaller than the inner dimension of the respective curb through holes (112), junction box through holes (122), corner box through holes (132), inserted from a determined distance inside the through holes of the adjacent connection elements and remaining fixed therein, or they can present fastening connection elements, of the “LEGO part” type. The connecting elements can be made from the same material as the curb elements (11, 11′), the junction box elements (12, 12′) and the corner box elements (13,13′), or they can be made of a different material. For example, the connecting elements can be made from a lighter material than concrete, such as a plastic material, other polymer material, fiber material, reinforced or not, for example, carbon fiber, or they can be made of a suitable metal, for example, aluminum or stainless steel.

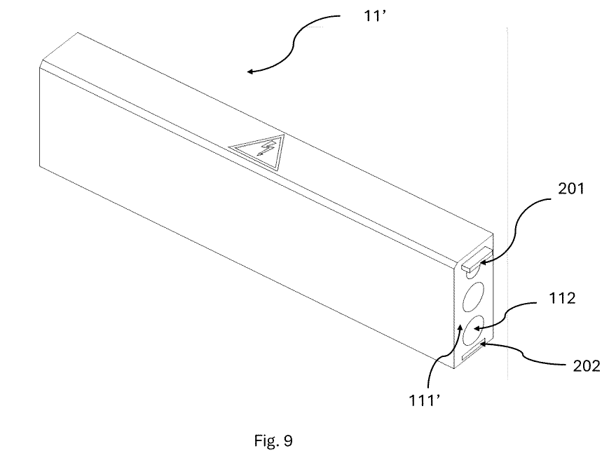

FIG. 9 illustrates a curb element (11′) wherein a ridge (201) and a groove (202) are visible at one of the side faces thereof (111′), destined to fit, respectively, in a groove (202) and a ridge (201) of, for example, an adjacent curb element (11′). As will be understood by a person skilled in the art, it will be advantageous to provide a ridge (201) in a higher area of the side face (111′) of the curb element (11′) and in an area of the opposite side face (111′) (not visible) of the curb element (11′). An identical arrangement can be made for other curb elements (11) or junction box elements (12, 12′) or corner box elements (13, 13′), now shown in the figures.

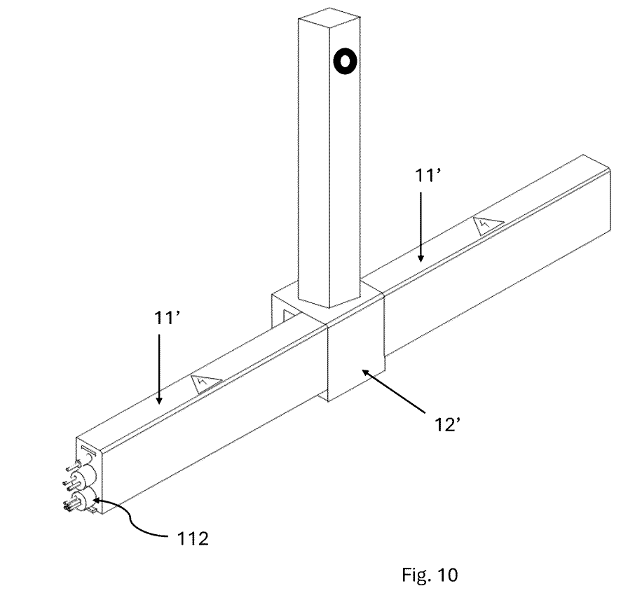

FIG. 10 illustrates a section of an embodiment of the modular system (10′) according to the invention. In FIG. 10 there is illustrated a junction box (12′) connected to two curb elements (11′), one on each side of the junction box (12′). Over the upper face of the junction box (12′) there is illustrated a charger for electric vehicles.

Still in FIG. 10 there is shown the wiring inserted in the curb through holes (112).

In embodiments of a first aspect, the present invention is related to a modular system (10, 10′) for the passage of wiring and connections which comprises:
at least one curb element (11,11′);
at least one junction box element (12,12′);
at least one junction box cover (15); and
at least one cover removal device (16);
wherein
said at least one curb element (11, 11′) is a massive solid comprising, in the interior thereof, at least one curb through hole (112) which crosses it longitudinally, from a curb side face (111, 111′) to the other, opposite curb side face (111, 111′);
said at least one junction box element (12, 12′) comprises, on each of the opposite side faces of the junction box (121, 121′) at least one junction box through hole (122) giving access to an interior of the junction box (123) and comprising, in the upper face thereof, at least one junction hole (124), wherein said junction hole (124) is the entrance of a junction channel (124a), which junction channel (124a) communicates, through a derivation channel (125), with said interior of the junction box (123);
said at least one junction box cover (15) is removable by means of said at least one cover removal device (16); and
each of said at least one curb element (11, 11′) and each of said at least one junction box element (12, 12′) are bordered by their curb side faces (111, 111′) and junction box side faces (121, 121′) opposite, respectively, with other curb side faces (111, 111′) and other junction box side faces (121, 121′) of other curb elements (11, 11′) and other junction box elements (12, 12′), respectively, wherein within said boundary,
the at least one curb through hole (112) is aligned top-to-top with the at least one junction box through hole (122), or with the at least one curb through hole (112) of another curb element (11, 11′); and/or
the at least one junction box through hole (122) is aligned top-to-top with the at least one junction box through hole (122) of another junction box through hole (12,12′).

In other embodiments of the first aspect, the modular system of the present invention further comprises:
at least one corner box element (13,13′);
at least one corner box cover (17);
wherein
said at least one corner box element (13, 13′) comprises, on each of the two adjacent side faces of the corner box (131, 131′), at least one corner box through hole (132) which gives access to an interior of the corner box (133); and
each one of said at least one corner box element (13, 13′) is bordered, by their corner box side faces (131, 131′), with other curb side faces (111, 111′), other junction box side faces (121,121′) and other corner box side faces (131, 131′) of other curb elements (11, 11′), other junction box elements (12, 12′), and other corner box elements (13, 13′) respectively, wherein, within said boundary, the at least one corner box through hole (132) is aligned top-to-top with the at least one junction box through hole (122), or with the at least one curb through hole (112), or with the at least one corner box through hole (132), of another corner box element (13,13′).

In still other embodiments of the first aspect, a front face (113) portion of the curb element (11) of the junction box (12) and/or corner box element (13) comprises an inclination at an angle comprised within the range from 0° to 90° with the upper face of the curb element (11), or with the upper face of the junction box (12) or with the upper face of the corner box element (13), respectively.

In still other embodiments of the first aspect, the at least one curb element (11, 11′), the at least one junction box element (12, 12′) the at least one junction box cover (15), and/or the at least one corner box element (13, 13′) and respective corner box cover (17) are made from a concrete material comprising cement, bottom ash, crushed limestone, said, recycled concrete, recycled glass, and adjuvants and/or other bituminous materials; the at least one junction box cover (15) and the at least one corner box cover (17) are optionally made from a different material from that of the junction box (12) and corner box (13 elements selected from the group consisting of: metal, plastic, polymer, glass, wood, rubber, fiber or any combination thereof.

In still other embodiments of the first aspect, said concrete material further comprises propylene fiber and/or other natural or synthetic polymers.

In still other embodiments of the first aspect, two or more curb through holes (112) have equal dimensions to each other or different from each other, two or more junction box through holes (122) have equal dimensions to each other or different from each other, and/or two or more corner box through holes (132) have equal dimensions to each other or different from each other.

In still other embodiments of the first aspect, the modular system (10, 10′) of the invention further comprises on at least one of curb side face (111, 111′), junction box side face (121, 121′), corner box side face (131, 131′), one or more connecting elements selected from the group consisting of: one or more connection tubes, one or more ridges (201) and/or one or more grooves (202), which fit into one or more grooves (202) and/or one or more ridges (201), respectively, of at least one of curb side face (111, 111′), junction box side face (121, 121′), and/or corner box side face (131, 131′), the boundary(s) thereof.

In a second aspect, the present invention is related to a use of the modular system (10, 10′) for passage of wiring and connections of the first aspect comprising the passing of wiring selected from the group consisting of: electrical cables, communication cables, connecting wires, optical fiber, by one or more curb through hole (112) and by one or more junction box through hole (122); and in the installation of connections selected from the group constituted by: electrical cable connections, communication cable connections, connecting wires connections, optical fiber connections inside the junction box (12, 12′), which connect said wiring to another wiring that passes through at least one junction hole (124), connectable to at least one external apparatus selected from the group consisting of: electric vehicle chargers, parking meters, lamps for public lighting, urban information furniture, bus stops, charging device for bicycles or scooters, telecommunication antennas, automatic vending machines, ticket purchasing terminals wherein said installation comprises the removal and replacement of the junction box cover (15) by means of the at least one cover removal device (16).

In a third aspect, the present invention is related to a use of the modular system (10, 10′) for passage of wiring and connections of the first aspect comprising the passage of wiring selected from the group consisting of:
electrical cables, communication cables, connecting wires, optical fiber, through the one or more curb through hole (112) and through the one or more junction box through hole (122) and through the one or more corner box through hole (132); and in installation of connections selected from the group constituted by: electrical cable connections, communication cables connections, connecting wires connections, optical fiber connections inside the junction box (12, 12′), which connect said wiring to another wiring that passes through the at least one junction hole (124) connectable to at least one external apparatus selected from the group constituted by: electric vehicle chargers, parking meters, lamps for public lighting, urban information furniture, bus stops, charging device for bicycles or scooters, telecommunication antennas, automatic vending machines, ticket purchasing terminals wherein said installation and passage of wiring comprises the removal and replacement of the junction box cover (15) and of the corner box cover (17) by means of the at least one cover removal device (16).

### Definitions

As used in this patent application, the expressions “about” and “approximately” refer to an interval of values of more or less 10% the specified number.

As used throughout this patent application, the expression “or” is used in the inclusive sense instead of the exclusive sense, unless the exclusive sense is clearly defined in a specific situation. In this context, a sentence of the type “X uses A or B” must be interpreted as including all the inclusive pertinent combinations, for example “X uses A”, “X uses B” and “X uses A and B”.

As used throughout this patent application the indefinite article “one” must be generally interpreted as “one or more”, and “one or more”, unless the sense of a single modality is clearly defined in a specific situation.

As presented in this description, the expressions related to examples must be interpreted with the purpose of illustrating an example of something and do not indicate a preference.

The subject matter described above is provided as an illustration of the present invention and, therefore, cannot be interpreted so as to limit it. The terminology used herein with the purpose of describing preferred embodiments of the present invention, must not be interpreted to limit the invention. As used in the specification, the definite and indefinite articles, in their singular form, aim at the interpretation of also including the plural forms, unless the context of the description indicates, explicitly, the contrary. It will be understood that the expressions “comprise” and “include”, when used in this description, specify the presence of the characteristics, the elements, the components, the steps and the related operations, however, they do not exclude the possibility of other characteristics, elements, components, steps and operations also being contemplated.

All the alterations, providing that they do not modify the essential characteristics of the claims that follow, must be considered as being within the scope of protection of the present invention.

### LIST OF REFERENCE INDICATIONS

10, 10′—modular system
11, 11′—curb element
12, 12′—junction box element
13, 13′—corner box element
15—junction box cover
16—cover removal device
17—corner box cover
111, 111′—curb side face
112—curb through hole
121, 121′—junction box side faces
122—junction box through hole
123—interior of junction box
124—connection hole
124a—connections channel
125—derivation channel
131, 131′—corner box side faces
132—corner box through hole
133—interior of corner box
201—ridge
202—groove

### LIST OF CITATIONS

Follow the list of citations:

### PATENT LITERATURE

Swedish patent application SE 2250811 A1, of applicant WAYBLER A B [SE], published on Dec. 19, 2023.

1. Modular system (10, 10′) for passage of wiring and connections characterized by comprising:
at least one curb element (11,11′);
at least one junction box element (12,12′);
at least one junction box cover (15); and
at least one cover removal device (16);
wherein
said at least one curb element (11, 11′) is a massive solid comprising, in the interior thereof, at least one curb through hole (112) which crosses it longitudinally, from a curb side face (111, 111′) to the other, opposite, curb side face (111, 111′);
said at least one junction box element (12, 12′) comprising, on each of the opposite side faces of the junction box (121, 121′) at least one junction box through hole (122) giving access to an interior of the junction box (123) and comprising, in the upper face thereof, at least one junction hole (124), wherein said junction hole (124) is the entrance of a junction channel (124a), which junction channel (124a) communicates, through a derivation channel (125), with said interior of the junction box (123);
said at least one junction box cover (15) being removable by means of said at least one cover removal device (16); and
each of said at least one curb element (11, 11′) and each of said at least one junction box element (12, 12′) abut, by their curb side faces (111, 111′) and junction box side faces (121, 121′) opposite, respectively, with other curb side faces (111, 111′) and other junction box side faces (121, 121′) of other curb elements (11, 11′) and other junction box elements (12, 12′), respectively, wherein in said boundary,
the at least one curb through hole (112) is aligned top-to-top with the at least one junction box through hole (122), or with the at least one curb through hole (112) of another curb element (11,11′); and/or
the at least one junction box through hole (122) is aligned top-to-top with the at least one junction box through hole (122) of another junction box through hole (12,12′).

2. The modular system (10,10′) according to claim 1, characterized by further comprising:
at least one corner box element (13,13′);
at least one corner box cover (17);
wherein
said at least one corner box element (13, 13′) comprises, on each one of the two adjacent corner box side faces (131, 131′), at least one corner box through hole (132) which gives access to the interior of the corner box (133); and
each one of said at least one corner box element (13, 13′) is bordered, by their corner box side faces (131, 131′), with other curb side faces (111, 111′), other junction box side faces (121,121′) and other corner box side faces (131, 131′) of other curb elements (11, 11′), other junction box elements (12, 12′), and other corner box elements (13, 13′) respectively, wherein, within said boundary, the at least one corner box through hole (132) is aligned top-to-top with the at least one junction box through hole (122), or with the at least one curb through hole (112), or with the at least one corner box through hole (132), of another corner box element (13,13′).

3. The modular system (10, 10′) according to claim 1, characterized by at least one front face (113) of the curb element (11) of the junction box (12) element and/or corner box element (13) comprising an inclination at an angle comprised within the range from 0° to 90° with the upper face of the curb element (11), or with the upper face of the junction box (12) or with the upper face of the corner box element (13), respectively.

4. The modular system (10,10′) according to claim 1, characterized by the at least one curb element (11, 11′), the at least one junction box element (12, 12′) the at least one junction box cover (15), and/or the at least one corner box element (13, 13′) and respective corner box cover (17) being made from a concrete material comprising cement, bottom ash, crushed limestone, recycled concrete, recycled glass, and adjuvants and/or other bituminous materials; or the at least one junction box cover (15) and the at least one corner box cover (17) being optionally made from a different material from that of the junction box (12) and corner box (13 elements selected from the group constituted by: metal, plastic, polymer, glass, wood, rubber, fiber or any combination thereof.

5. The modular system (10,10′) according to claim 4, characterized by said concrete material further comprising propylene fiber and/or other natural or synthetic polymers.

6. The modular system (10,10′) according to claim 5, characterized by two or more curb through holes (112) having equal dimensions to each other or different from each other, two or more junction box through holes (122) having equal dimensions to each other or different from each other, and/or two or more corner box through holes (132) having equal dimensions to each other or different from each other.

7. The modular system (10,10′) according to claim 6, characterized by further comprising, on at least one of curb side face (111, 111′), junction box side face (121, 121′), corner box side face (131, 131′), one or more connecting elements selected from the group constituted by: one or more connection tubes, one or more connection bushings, one or more connection cylinders having a determined length inserted inside the respective curb through holes (122), junction box through hole (122) and/or corner box through holes (132) of two adjacent elements, one or more ridges (201) and/or one or more grooves (202), which fit into one or more grooves (202) and/or one or more ridges (201), respectively, of at least one of curb side face (111, 111′), junction box side face (121, 121′), and/or corner box side face (131, 131′), the boundary(s) thereof.

8. Use of the modular system (10, 10′) for passage of wiring and connections, as defined in claim 1, characterized by the use comprising the passage of wiring selected from the group consisting of: electrical cables, communication cables, connecting wires, optical fiber, by the one or more curb through hole (112) and by the one or more junction box through hole (122); and by the installation of connections selected from the group consisting of: electrical cable connections, communication cable connections, connecting wires connections, optical fiber connections inside the junction box (12, 12′), which connect said wiring to another wiring that passes through at least one junction hole (124), connectable to at least one external apparatus selected from the group consisting of: electric vehicle chargers, parking meters, lamps for public lighting, bus stops, charging device for bicycles or scooters, telecommunication antennas, automatic vending machines, ticket purchasing terminals wherein said installation comprises the removal and replacement of the junction box cover (15) by means of the at least one cover removal device (16).

9. Use of the modular system (10, 10′) for passage of wiring and connections, as defined in claim 2, characterized by the use comprising the passing of wiring selected from the group constituted by: electrical cables, communication cables, connecting wires, optical fiber, through one or more curb through hole (112) and through one or more junction box through hole (122) and through the one or more corner box through hole (132); and in installation of connections selected from the group constituted by: electrical cable connections, communication cables connections, connecting wire connections, optical fiber connections inside the junction box (12, 12′), which connect said wiring to another wiring that passes through the at least one junction hole (124) connectable to at least one external apparatus selected from the group constituted by: electric vehicle chargers, parking meters, lamps for public lighting, urban information furniture, bus stops, charging device for bicycles or scooters, telecommunication antennas, automatic vending machines, ticket purchasing terminals wherein said installation and passage of wiring comprises the removal and replacement of the junction box cover (15) and of the corner box cover (17) by means of the at least one cover removal device (16).
